(19) United States
(12) Patent Application Publication
(10) Pub. No.: US 2018/0224852 A1
(43) Pub. Date: Aug. 9, 2018

(54) AUTO-DRIVE APPARATUS

(71) Applicant: DENSO CORPORATION, Kariya-city (JP)

(72) Inventors: Akihito Tanahashi, Kariya-city (JP); Toshiyuki Ito, Kariya-city (JP); Takahiro Naganuma, Kariya-city (JP)

(21) Appl. No.: 15/887,384

(22) Filed: Feb. 2, 2018

(30) Foreign Application Priority Data
Feb. 6, 2017 (JP) 2017-19664

(51) Int. Cl. G05D 1/00; G05D 1/02

(52) U.S. Cl. CPC G05D 1/0088; G05D 1/0214; G05D 1/0061; G05D 1/0278; G05D 2201/0213; G05D 1/027; G05D 1/0274

(57) ABSTRACT

An auto-drive apparatus includes a condition determiner for determining whether an auto-drive start condition of a vehicle is satisfied based on a detection of a boarding action by a user. When no destination has been set at a time when the auto-drive start condition is satisfied, a temporary destination setter sets a temporary destination, which is a position on a nearby road that is reachable in a minimum travel time or via a shortest travel distance from a current vehicle position. An auto-drive processor plans a route to the temporary destination and starts the auto-drive of the vehicle toward the temporary destination.

### CROSS REFERENCE TO RELATED APPLICATION

The present application is based on and claims the benefit of priority of Japanese Patent Application No. 2017-019664, filed on Feb. 6, 2017, the disclosure of which is incorporated herein by reference.

### TECHNICAL FIELD

The present disclosure generally relates to an auto-drive apparatus that automatically drives, or controls a travel of, a subject vehicle to a preset destination.

### BACKGROUND INFORMATION

In recent years, as disclosed in a patent document 1, i.e. Japanese Application Publication No. 2012-216069, an occupant in a vehicle's driver's seat (hereinafter referred to as “a driver seat occupant”) can rely on an autopilot/auto-drive function that automatically drives the vehicle and controls vehicle travel toward a preset destination.

As described in patent document 1, in cases where the driver seat occupant turns ON the auto-drive function where no destination is set, the vehicle is controlled to continue automatically driving along a current road or to travel under automatic control to a location where the vehicle can be safely stopped and put into park.

With the travel controller disclosed in the patent document 1, if the current road is identifiable by the vehicle and/or travel controller when no destination has been set, the vehicle may still travel using the auto-drive function. However, when the vehicle described in patent document 1 is not currently traveling on the road, the vehicle cannot start the auto-drive function without a destination setting. For example, a driver's seat occupant entering a parked vehicle in a parking lot cannot start the vehicle described in patent document 1 and engage the auto-drive function without first providing a destination. In other words, occupancy alone of a running vehicle not currently traveling along a road known to the vehicle and/or travel controller is not sufficient for starting the auto-drive function of the vehicle, because the travel controller in patent document 1 relies on either identifying a current road of travel or a defined travel destination to engage the auto-drive function. Further, the auto-drive function for the vehicle traveling on a known road is performable only when the vehicle is already traveling on a road. As such, a vehicle that is near the known road but not currently traveling on the known road cannot engage the auto-drive function. For example, a driver's seat occupant entering a vehicle parked in a parking lot next to the known road cannot start the vehicle and engage the auto-drive function so that the vehicle travels along the known-road.

Thus, after starting a parked vehicle, a driver's seat occupant following the technique described in patent document 1 must program a destination into the travel controller before an auto-drive function may be engaged. The input and programming (i.e., “setting”) of a travel destination requires a certain amount of time, and this amount of time may be a waste of the driver seat occupant's time depending on how quickly the auto-drive function may be engaged after starting the vehicle from a parked condition.

As used herein, “trip” may be used to indicate a moving vehicle operation or series of travels (i.e., driving) of a vehicle from when the vehicle ignition is turned ON until the ignition is turned OFF. “Trip” may be used as a framework for counting the number of times travel is performed using the auto-drive function or to describe manual travel, for example, as a first trip, second trip, etc.

### SUMMARY

It is an object of the present disclosure to provide an auto-drive apparatus that is capable of engaging an auto-drive function during a trip of the subject vehicle without a destination setting.

In an aspect of the present disclosure, an auto-drive apparatus in a subject vehicle may include a destination obtainer configured to obtain a travel destination for the subject vehicle and an auto-drive processor configured to control an automatic drive of the subject vehicle toward the travel destination. The auto-drive apparatus may further include a condition determiner configured to determine whether a start condition for engaging an automatic drive function is satisfied based on an input signal from a device disposed within the subject vehicle. The auto-travel start condition may be a condition or a criterion, for engaging the auto-drive function of the subject vehicle when the subject vehicle is in a stopped or parked state. The auto-drive apparatus may further include a temporary destination setter configured to set a temporary destination according to a preset rule when the destination obtainer does not obtain a travel destination within a preset amount of time. The preset amount of time may have a similar duration of the time it takes the condition determiner to determine whether a start condition for engaging the automatic drive function is satisfied. In other words, if the condition determiner determines a start condition is satisfied and no travel destination has been obtained by the destination obtainer, the temporary destination setter may set a temporary destination. The auto-drive processor may start the automatic drive of the subject vehicle toward the temporary destination if no destination has been obtained by the destination obtainer prior to the determination of the start condition by the condition determiner.

According to the above configuration, the auto-drive processor starts the automatic drive of the subject vehicle toward a temporary destination when a driver seat occupant is in the subject vehicle and the condition determiner determines that a predetermined automatic drive start condition has been satisfied if the destination obtainer does not have (i.e., has not obtained) a set travel destination.

The above-described configuration allows the automatic start of the automatic drive function in a subject vehicle without the driver seat occupant/user having to set a travel destination, so long as an action is performed that satisfies the automatic drive start condition. The automatic drive start condition does not include the setting of a travel destination. Therefore, even when a travel destination is not set before the first engagement of the auto-drive function during a trip, the auto-drive function may still be engaged.

In another aspect of the present disclosure, an auto-drive apparatus in a subject vehicle may include a destination obtainer configured to obtain a travel destination for the subject vehicle and an auto-drive processor configured to control an automatic drive of the subject vehicle toward the travel destination. The auto-drive apparatus may further include a condition determiner configured to determine whether a start condition for engaging an automatic drive function is satisfied based on an input signal from a device disposed within the subject vehicle. The auto-travel start condition may be a condition or a criterion, for engaging the auto-drive function of the subject vehicle when the subject vehicle is in a stopped or parked state.

The auto-drive apparatus may further include a temporary travel direction setter configured to set a travel direction of the subject vehicle to a road closest to or proximate to the current position of the subject vehicle according to a preset rule when the destination obtainer does not obtain a travel destination prior to the start condition determination by the condition determiner. The auto-drive processor engages the automatic drive of the subject vehicle to drive the vehicle on the road that is closest to or proximate to the subject vehicle, if no travel destination is obtained by the destination obtainer prior to the condition determiner determining whether to engage the automatic drive function on the subject vehicle.

According to the above configuration, the auto-drive processor engages the auto-drive function of the subject vehicle to automatically drive the subject vehicle to a road near or proximate to the current location of the subject vehicle when a driver's seat occupant/user is present in the subject vehicle and the condition determiner determines that a start condition for the engaging the auto-drive function has been satisfied, if no set travel destination is obtained by the destination obtainer. Such a configuration also allows the subject vehicle to engage the auto-drive function without a user having to set travel destination prior to the engagement of the auto-drive function during a trip of the subject vehicle.

### BRIEF DESCRIPTION OF THE DRAWINGS

Objects, features, and advantages of the present disclosure will become more apparent from the following detailed description made with reference to the accompanying drawings, in which:

FIG. 1 illustrates a block diagram of an outline configuration of a vehicle control system;

FIG. 2 illustrates a block diagram configuration of an auto-drive ECU;

FIG. 3 is a flowchart of a condition determination process;

FIG. 4 illustrates an intention confirmation screen;

FIG. 5 illustrates a temporary destination selection screen;

FIG. 6 is a flowchart of a travel start related process performed by an auto-drive ECU 10;

FIG. 7 illustrates a block diagram configuration of an auto-drive ECU 10;

FIG. 8 illustrates a travel direction selection screen;

FIG. 9 is a flowchart of the travel start related process performed by an auto-drive ECU 10;

FIG. 10 illustrates a route confirmation screen;

FIG. 11 illustrates a block diagram configuration of an auto-drive ECU 10;

FIG. 12 illustrates a purpose confirmation screen;

FIG. 13 illustrates a purpose selection screen;

FIG. 14 is a flowchart of the travel start related process performed by an auto-drive ECU 10; and

FIG. 15 is a continuation of the flowchart shown in FIG. 14.

### DETAILED DESCRIPTION

### First Embodiment

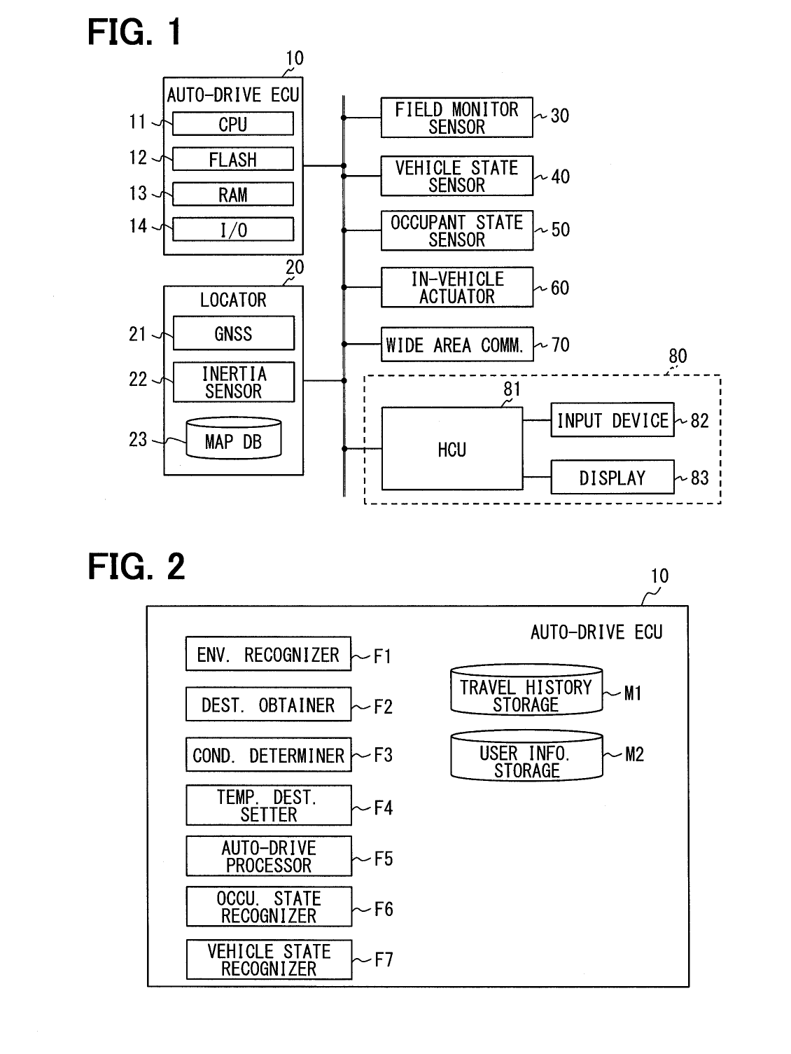

With reference to FIG. 1, the vehicle control system of the present embodiment may include an auto-drive ECU 10, a locator 20, a field monitor sensor 30, a vehicle state sensor 40, an occupant state sensor 50, an in-vehicle actuator 60, a wide area communicator 70, and an HMI system 80. ECU is an abbreviation for an Electronic Control Unit, that may be an electronic control circuit installed in a vehicle, and HMI is an abbreviation for a Human Machine Interface.

Each of the locator 20, the field monitor sensor 30, the vehicle state sensor 40, the occupant state sensor 50, the in-vehicle actuator 60, the wide area communicator 70, and the HMI system 80 is communicatively connected with the auto-drive ECU 10 via a communication network such as a Local Area Network or “LAN” within the subject vehicle. The vehicle having the vehicle control system may also be designated as a “subject vehicle” and a person using the subject may be designated as a “user.” An “occupant” indicates a user on board the subject vehicle, and the seating position of the occupant may not be limited to a driver's seat. When an occupant is seated in the driver's seat of the subject vehicle, such an occupant is specifically designated as a “driver's seat occupant.”

The vehicle control system operates in two operation modes, that is, a manual drive mode and an auto-drive mode. The manual drive mode drives or controls the subject vehicle based on a drive operation of the driver's seat occupant. In the auto-drive mode, the vehicle control system automatically controls the drive of the subject vehicle with the auto-drive ECU 10 with little to no control by the driver's seat occupant. Manual drive may not necessarily mean that a driver's seat occupant exercises complete manual control to drive the subject vehicle. That is, even when the drive operation of the subject vehicle is partially controlled by the driver's seat occupant, the subject vehicle may also be partially controlled by the auto-drive ECU 10 for speed control, steering control, and the like, but the operation mode may still be considered as the manual drive mode.

The auto-drive ECU 10 is an ECU that provides an automatic control function, such as an auto-drive function, to automatically control steering, acceleration, deceleration, and the like in the subject vehicle in lieu of control by the driver's seat occupant. The auto-drive ECU 10 corresponds to an auto-drive apparatus. The auto-drive ECU 10 may be or may include a computer and additional peripherals such as hardware. That is, the auto-drive ECU 10 may include a non-volatile type memory such as flash memory 12, a volatile type memory such as a random access memory (RAM) 13, and an input/output (I/O) 14, in additional to a central processing unit (CPU) 11 that performs various data processing, and a bus line for connecting the components of the auto-drive ECU to each other. The CPU 11 may be realized by using a microprocessor, etc. The I/O 14 is an interface used by the auto-drive ECU 10 to input and output data to and from an external device such as the field monitor sensor 30. The I/O 14 may be realized by an integrated circuit (IC), a digital circuit element, an analog circuit element, or the like.

The flash memory 12 stores, among other things, a program that is used to control the CPU 11 and the auto-drive ECU 10. The program may be designated as an auto-drive program. The auto-drive program may be stored in a non-transitory, tangible storage medium including the flash memory 12. The execution of the auto-drive program by the CPU 11 corresponds to the execution of the auto-driving methods and processes. That is, executing the auto-drive program instructs the auto-drive ECU 10, among other components, to perform the methods and processes used to realize the auto-drive function. The auto-drive ECU 10 executes the auto-drive program with the CPU 11 to provide various functions.

The locator 20 is a positioning device that determines a current position of the vehicle. The locator 20 is realized using a Global Navigation Satellite System (GNSS) receiver 21, an inertia sensor 22, and a map database (DB) 23. The GNSS receiver 21 is a device that detects the current position of the GNSS receiver itself by receiving a navigation signal transmitted from GNSS satellites, for example, at intervals of 100 milliseconds. The inertia sensor 22 may include, for example, a multi-axis gyroscope and a multi-axis accelerometer.

The map DB 23 is a nonvolatile memory that stores map data that may be used to generate and display an electronic visual representation of road maps showing the interconnection of vehicle roads, points of interest, and the like. The map data includes node data representing nodes and link data representing links for generating (i.e., drawing) the map(s). The map(s) may use nodes such as intersections, merge points, branch points, and the like, as well as links between the nodes, such as a roads, to generate an electronic map for display to the user of the subject vehicle. The map DB 23 may include data to generate high-resolution and highly accurate maps, including maps showing road surface markings such as lane dividers, and other lines, as well as traffic signals, road signs, entrances and exits (i.e., for highways, parking lots, etc.), and the like. The map data may also include data regarding the location of “emergency stoppage” areas or “safe areas”, such as shoulders, emergency lanes, pull offs, and other areas a vehicle may stop or park without impeding traffic on the road, and based on relevant traffic laws and regulations.

The locator 20 determines the current position of the subject vehicle by plotting a successive series of the subject vehicle's position using both the positioning data from the GNSS receiver 21 and a measurement result of the inertia sensor 22. The subject vehicle's position (i.e., position data) is output from the locator 20 to the LAN and is used by the auto-drive ECU 10 or other components. Based on the current position of the subject vehicle, the locator 20 is configured to process map data within a preset range, for example, map data covering a particular sized area surrounding the subject vehicle, and outputs such map data to the in-vehicle LAN. The map data may also be received from sources outside of the subject vehicle, for example from a data server that is part of an intelligent transportation system (ITS) framework, such as vehicular ad hoc network (VANETs), via the wide area communicator 70.

The field monitor sensor 30 is a device that collects information about an environment around the subject vehicle. The field monitor sensor 30 may be implemented as vehicle 360 degree camera that may image a preset range around the subject vehicle, a millimeter wave radar that transmits a search wave to a preset range around the vehicle, a LIDAR (i.e., Light Detection and Ranging/Laser Imaging Detection and Ranging), a sonar, or the like. A vehicle-to-vehicle (V2V) communication device may also be considered as the field monitor sensor 30, since it is capable of collecting environment information around the subject vehicle by data already gathered by other vehicles.

The field monitor sensor 30 identifies a relative position of a predetermined detection object relative to the subject vehicle, and provides the auto-drive ECU 10 with the data, which may be referred to herein as “nearby object data.” Based on the nearby object data, the field monitor sensor 30 may use such data to show the relative position of the detection object at regular intervals or in succession on the vehicle map. The detection object may be, for example, a pedestrian, an animal, another vehicle, a road-side structure, facility, and the like. The other vehicle may further be identified and specified, for example, as a bicycle, a motorcycle, or the like. The road-side structure may be, for example, a guard rail, a curb, a tree, a utility pole, a sign pole, a traffic signal, and the like. The detection object may further includes road surface markings, for example, showing vehicle lanes, in-road obstacles, such as item that may have fallen from a truck (i.e., lost loads), tires, roadkill, or other debris, and like objects.

The vehicle state sensor 40 is a sensor that detects a quantitative value from a vehicle sensor in connection with the travel control of the subject vehicle. The vehicle control system may include a brake sensor, an accelerator sensor, a speed sensor, a shift position sensor, and a steering angle sensor as the vehicle state sensor 40. The brake sensor senses a position of a brake pedal, that is, the brake sensor is a sensor that quantifies an amount of depression of the brake pedal or the brake depression amount by the driver seat occupant. The accelerator sensor senses a position of an accelerator, that is, the accelerator sensor is a sensor that quantifies an amount of depression of an accelerator pedal or an accelerator depression amount by the driver seat occupant. The speed sensor is a sensor that detects a travel speed of the subject vehicle. The shift position sensor is a sensor that detects a position of a gearshift. The steering angle sensor is a sensor that detects a rotation angle of a steering wheel or a steering angle.

Each of those sensors provides the auto-drive ECU 10 with quantitative data in which the current value (i.e., a detection result) of a physical value measured by the sensor is shown. The sensors may provide the auto-drive ECU 10 with data successively, that is sequentially or one after the other. Note that the type of the vehicle state sensors 40 provided in the travel control system may vary according to a design of the system, and the above-described sensors are exemplary types of sensors that may be used in the travel control system. A sensor other than the above, such as a yaw rate sensor or the like may also be provided in the system. The yaw rate sensor is a sensor that detects a rotation angle speed (i.e., a yaw rate) for a vertical axis of the subject vehicle.

The occupant state sensor 50 is a device that detects a state of the driver's seat occupant by sensing index information representing the state of the driver's seat occupant. As the index information representing the state of the driver's seat occupant, a face image and/or an upper body image of the driver's seat occupant as well as a pressure distribution of a seating surface of the driver's seat may be employable. Biometric information such as the occupant's heart rate, a respiratory interval, and/or brain waves is also usable as the index information representing the state of the driver's seat occupant. The occupant state sensor 50 may sense the different index information of the driver's seat occupant successively, that is, one after the other.

In the present embodiment, the occupant state sensor 50 detects, in succession, a driver state based on the facial image of the driver's seat occupant, which is known as a drive status monitor, or DSM. The DSM captures a face of a driver seat occupant by a near-infrared camera, and detects an orientation of the driver's face and a direction of sight, a degree of opening of an eyelid by performing an image recognition process on the captured image. The occupant state sensor 50 may also detect, as another mode of operation, a state of the driver's seat occupant based on the pressure distribution on the seating surface/seatback of the driver's seat as another mode of detection. The state of the driver's seat occupant may be identified by combining various kinds of the index information.

The DSM as the occupant state sensor 50 may be disposed at a position on a steering column cover, surface of the instrument panel facing the driver's seat occupant, or the like. That is, the DSM is so arranged and positioned to capture a face part of the driver's seat occupant sitting on the driver's seat. The occupant state sensor 50 outputs, in succession, information regarding the face orientation, the direction of sight, and the degree of opening of an eyelid of the driver's seat occupant to the auto-drive ECU 10, as occupant state data based on the captured image. The occupant state data corresponds to output data.

The occupant state sensor 50 in the present embodiment provides the auto-drive ECU 10 with the face image data of the driver's seat occupant as one mode. The facial image of the driver seat occupant may be provided to the auto-drive ECU 10 from a source other than the occupant state sensor 50. That is, for example, the facial image may be provided from a camera that is positioned on or around a rear view mirror or wide view mirror for viewing the interior occupancy compartment of the vehicle. The camera may be used for capturing the upper body of the driver seat occupant.

The in-vehicle actuator 60 is, for example, a throttle actuator of an electronically-controlled throttle, an injector, a brake actuator, a steering actuator, and the like. The in-vehicle actuator 60 operates based on a control signal that is output from the auto-drive ECU 10.

The wide area communicator 70 is a communication module that wirelessly accesses a wide area network, which enables the communication between the vehicle control system in the subject vehicle and the other communication devices connected to the wide area network.

The HMI system 80 is provided with an HCU (i.e., HMI Control Unit) 81, an input device 82, and a display 83, and receives an input operation from the driver's seat occupant, or presents information to the driver's seat occupant. The HCU 81 is configured to integrally control both of (i) the acquisition of the operation information that is input by the occupant via the input device 82 and (ii) the presentation of information to the occupant via the display 83. Information presentation to the occupant may be realized by using a loudspeaker, a vibrator to provide tactile feedback, a lighting device or other visual display, and the like. The HCU 81 may also be realized by using a CPU, a RAM, a flash memory, and the like.

The input device 82 is a device for receiving an occupant's instruction operation to the various electronic devices or in-vehicle apparatuses in the subject vehicle, such as a navigation device, audio equipment, an air-conditioner, and the like. The input device 82 also functions as a device for receiving an operation from the occupant for operating and stopping the auto-drive function. The operating state of the auto-drive function is realized by the vehicle control system having its operation mode set to the auto-drive mode, and the stop state of the auto-drive function is realized by the vehicle control system having its operation mode set to the manual drive mode.

The input device 82 may be provided, for example, as a touch panel on the display 83. The touch panel serving as the input device 82 outputs, in succession, the position of a touch by the occupant as an operation signal (i.e., as a touch position signal) for the in-vehicle devices and for the auto-drive ECU 10. That is, the input device 82 outputs a control signal corresponding to the touch operation performed by the occupant for a relevant in-vehicle apparatus.

Although a touch panel is provided as the input device 82 in the present embodiment, the input device 82 may not be limited to a touch panel. The input device 82 may be implemented as a mechanical switch disposed on a steering wheel (i.e., may be a steering switch), or may also be a voice/sound input device using voice/sound recognition. The input device 82 may be a haptic device disposed on a center console or the like. The input device 82 may also be other devices such as a mouse, a keyboard, or the like. The vehicle control system may be provided with two or more of the above-described devices as the input device 82.

The display 83 is a device that displays an image input from the HCU 81. The display 83 may be provided as a center display disposed at a center, top-most portion in a widthwise direction of an instrument panel. The display 83 may display an image in full color by using a liquid crystal display device, an organic electro-luminescence display device, a plasma display device, or the like.

The display 83 may also be realized as a HUD (i.e., Head-up Display) that projects a virtual image on a part of a windshield in front of the driver's seat occupant. The display 83 may also be a meter-display device that is positioned on a portion of the instrument panel facing the driver's seat occupant.

<Function of the Auto-Drive ECU 10>

The auto-drive ECU 10 provides various functions corresponding to the various functional blocks shown in FIG. 2, by controlling the CPU 11 to execute the above-mentioned auto-drive program. That is, the auto-drive ECU 10 is provided with hardware to execute the functions of the functional blocks, for example, an environment recognizer F1, a destination obtainer F2, a condition determiner F3, a temporary destination setter F4, an auto-drive processor F5, an occupant state recognizer F6, and a vehicle state recognizer F7.

The functional blocks provided by the auto-drive ECU 10 may be realized in part or as a whole as hardware, for example by using a logical circuit or the like. The hardware may be constituted by one IC or by a plurality of ICs. The functional blocks provided by the auto-drive ECU 10 may also be realized, in part or as a whole, as a combination of software & hardware, i.e., as a combination of the execution of software by CPU 11 and the hardware components.

Further, the auto-drive ECU 10 is provided with a travel history storage M1 and a user information storage M2. The travel history storage M1 is a storage area where travel history data including a history of roads traveled by the subject vehicle is saved and stored. The travel history data may be, for example, data related to the number of travel times for each link. The travel history storage M1 may be realized by using a memory medium that is a non-volatile, rewritable memory such as the flash memory 12 or the like.

The user information storage M2 is a storage area where an authorized user data is stored. Authorized user data is information about the user or “authorized user” who can use the auto-drive function. The user information storage M2 may also be realized by using a memory medium that is a non-volatile, rewritable memory such as the flash memory 12 or the like. Authorized user data is data used by the condition determiner F3 for determining whether a person seated in the driver's seat is an authorized user. In the present embodiment, authorized user data may be a facial image of the authorized user, for example.

An auto-drive authorized person may also be referred to as an authorized user, and authorized user data may also be referred to as authority data. The user information storage M2 may also be referred to as an authority data storage. The authorized user is, in other words, a person who is allowed or has the authority to operate the auto-drive function of the subject vehicle via the auto-drive ECU 10.

As another mode of operation, the authorized user data may be data related to a facial feature of an authorized user. Alternatively, the authorized user data may also be an authorized user's voice print or voice signature and/or fingerprint information. The authorized user data may also be a unique identification number set by the authorized user. The authorized user data may be a terminal ID currently assigned to a portable terminal/device carried by the authorized user. The authorized user may be a person who at least has a driver's license. The authorized user data is registered based on a user operation.

The environment recognizer F1 obtains position information and map data from the locator 20. The environment recognizer F1 recognizes a shape and a movement state of a nearby object around the subject vehicle, based on the detection result of the field monitor sensor 30. By combining the detection result of the field monitor sensor 30 with the map data around the subject vehicle, a virtual space reproducing an actual travel environment in three dimensions is generated.

The destination obtainer F2 obtains information about a position/spot specified as a destination by the driver's seat occupant via the HMI system 80, i.e., the destination obtainer F2 obtains destination information, and sets the position/spot as the destination. The destination obtainer F2 may also obtain the destination information from a server (i.e., a destination distribution server, hereafter) that is a facility outside of the subject vehicle via the wide area communicator 70, as another mode of operation.

The destination distribution server is a server that distributes the destination information of the next trip registered by the user at any time to the subject vehicle. The user can input/register the destination of the next trip to the server in advance via an information processing device, such as a smart phone. The wide area communicator 70 provides the auto-drive ECU 10 with the corresponding or relevant data, when the destination data from the destination distribution server is received. The term “trip” refers a travel operation or a series of travels of a vehicle between a turning ON and a turning OFF of an ignition switch (i.e., a power source for a travel of the vehicle), that is, a series of travels from when a user boards the vehicle until the user parks the vehicle.

The destination obtainer F2 provides already-obtained destination information to an inquiry from the auto-drive processor F5 or the like, when the destination information has been obtained. The auto-drive processor F5 sets the position/spot shown in the destination information provided from the destination obtainer F2 as the destination. When the destination information has not been obtained, the data indicative of no destination setting is returned from the destination obtainer F2 in response to the inquiry from the auto-drive processor F5 or the like.

The condition determiner F3 determines, in succession, whether an auto-drive start condition is satisfied based on the data provided from the vehicle state sensor 40. The auto-drive start condition is a condition for starting an automatic travel from a stop state, which may be paraphrased as a still-stopped state of a vehicle after boarding by the user/occupant. In other words, the auto-drive start condition is a condition allowing the auto-drive ECU 10 to start a first auto-drive after the user/occupant boards the subject vehicle.

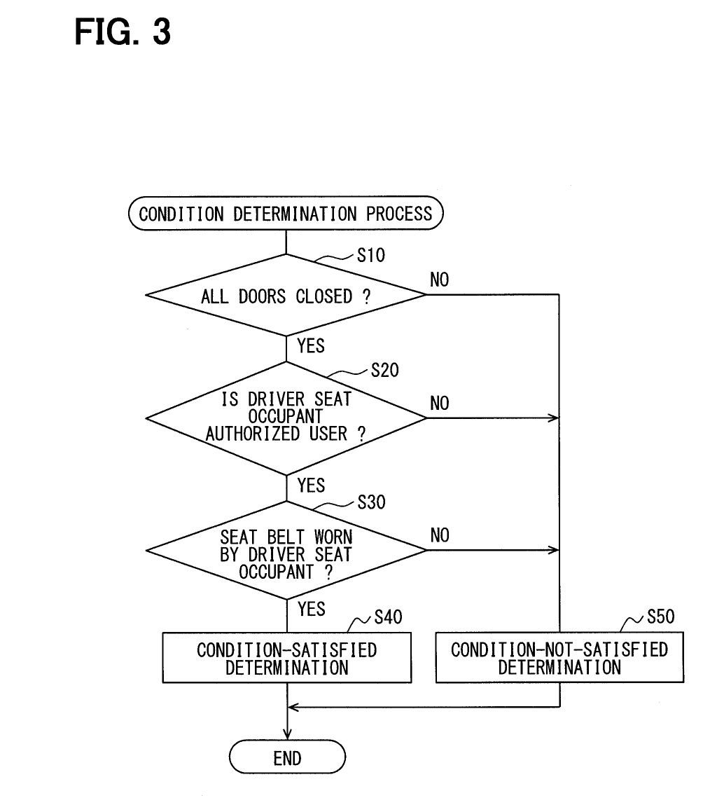

FIG. 3 illustrates a flowchart of a condition determination process, which is performed by the condition determiner F3, in order to determine whether the auto-drive start condition is satisfied. The condition determination process shown in FIG. 3 may be performed at a predetermined cycle based on a detection of a boarding action of an occupant mentioned later. When it is once determined that the auto-drive start condition is satisfied, such determination result may be kept/retained until a predetermined event is observed/detected, e.g., until a door is opened or the like.

The condition determiner F3 determines whether all the doors of the subject vehicle are closed at S10 of the condition determination process. The open-close condition of the doors in the subject vehicle is determined, for example, based on the output of a courtesy switch disposed in each door. When all the doors are closed, an affirmative determination is performed at S10, and the process proceeds to S20. On the other hand, when at least one door is determined as open, a negative determination is performed at S10, and the process proceeds to S50.

At S20, the face image data provided from the occupant state sensor 50 is compared with the authorized user data registered to the user information storage M2, and it is determined whether the driver's seat occupant is an authorized user. When the driver's seat occupant is an authorized user, an affirmative determination is performed at S20, and the process proceeds to S30. On the other hand, when the driver's seat occupant is not an authorized user, a negative determination is performed at S20, and the process proceeds to S50. The condition determiner F3 performing the process at S20 corresponds to an occupant determiner.

Although, in the configuration of the present embodiment, the driver's seat occupant is determined whether he/she is an authorized user registered in advance by using the driver seat occupant's facial image, such determination may be performed differently. For example, the driver's seat occupant may be identified by using a fingerprint authentication technique and/or a voiceprint authentication technique. Alternatively, by pre-registering a terminal ID of the portable terminal/device carried by an authorized user and examining whether the portable terminal/device with the registered terminal ID exists in proximity to the driver's seat, the driver's seat occupant may be determined as an authorized user. The position of a portable terminal/device may be identified by receiving a signal from the portable terminal/device with two or more antennas. Whether the driver's seat occupant is an authorized user may also be determined by other methods other than the above.

At S30, it is determined whether the driver's seat occupant is wearing a seat belt. The wearing condition of the seat belt by the driver's seat occupant may be detected by a well-known configuration in the art. When the seat belt for the driver's seat occupant is in a worn state, an affirmative determination is performed at S30, and the process proceeds to S40. On the other hand, when the seat belt for the driver's seat occupant is not in a worn state, a negative determination is performed at S30, and the process proceeds to S50.

At S40, it is determined that the auto-drive start condition is satisfied, and the flow comes to an end. At S50, the auto-drive start condition is determined as not satisfied, and the flow comes to an end. When the auto-drive start condition is satisfied, the operation mode of the vehicle control system is set to the auto-drive mode.

Each step in the flowchart of FIG. 3 serves as a sub-condition that collectively constitutes the auto-drive start condition. That is, when the boarding of the occupant is complete (i.e., YES at S10), when a specific user is seated on the driver's seat (i.e., YES at S20), and when the driver's seat occupant is wearing the seat belt (YES at S30), the auto-drive start condition is determined as satisfied based on the satisfaction of each of the sub-conditions.

According to such configuration, when an authorized user boards the subject vehicle as a driver's seat occupant and wears a seat belt, it is determined that the auto-drive start condition is satisfied. In other words, the authorized user can satisfy the auto-drive start condition without performing any special operation. As a result, an authorized user's convenience is improved.

Further, by including a sub-condition that the authorized user is seated in the driver's seat in the auto-drive start condition, an inadvertent start of the travel of the subject vehicle by a child is prevented. As another mode of operation, the sub-condition about the position of the seating of the authorized user may be not necessarily limited to the driver's seat. That is, the sub-condition may be set simply as the boarding of an authorized user.

The auto-drive start condition may further be modified from the one described in the above. For example, the wearing of a seat belt may be excluded from the sub-condition. Disengaging the parking brake may be included in the sub-condition. The contents of the auto-drive start condition may be designed suitably and arbitrarily. However, setting a destination will not be included as the auto-drive start condition.

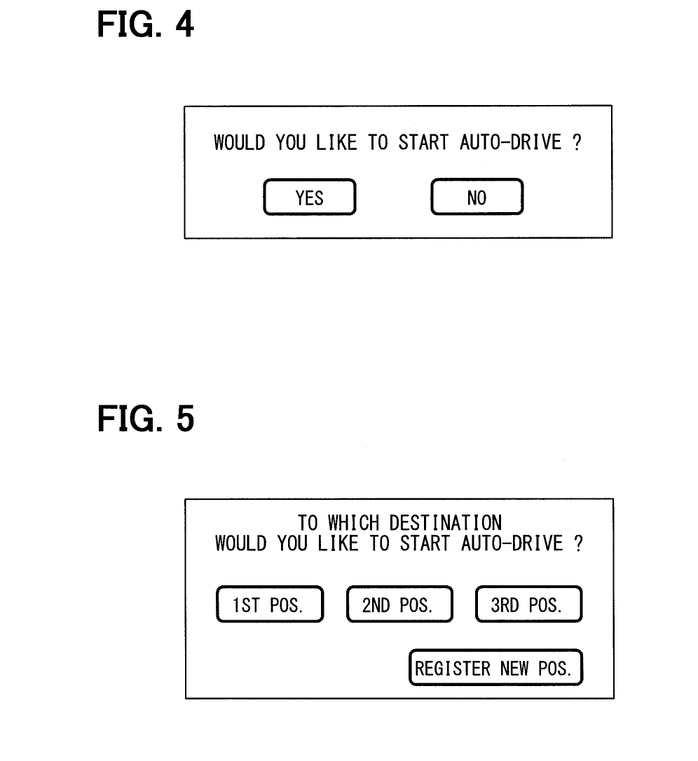

Further, a display of an intention confirmation screen on the display 83 under control of the HCU 81, which confirms whether to start the auto-drive as shown in FIG. 4, may be included as a sub-condition, which is then determined as satisfied when the user indicates Yes by his/her operation. In such case, the user operation may be detected and determined solely by the HCU 81, or may be detected by the HCU 81 and determined by the condition determiner F3 based on the operation information provided by the HCU 81.

The intention of the occupant regarding whether he/she would like to start the auto-drive may also be confirmed by a dialogue, i.e., a combination of an output inquiry voice message and an input of an answer voice from the driver's seat occupant, without using a screen display. The intention confirmation process regarding whether to start the auto-drive may be performed when all other sub-conditions constituting the auto-drive start condition are satisfied.

Information regarding whether to permit a start of the auto-drive (i.e., auto-drive start permission information) may be registered by the user in advance. The auto-drive start permission information may be set and stored/saved in the user information storage M2 in association with the authorized user data.

The temporary destination setter F4 sets a position according to a predetermined rule as a temporary destination, when the auto-drive start condition is satisfied by the condition determiner F3, if the destination obtainer F2 has not yet obtained the destination information prior to the condition determiner F3 satisfying the auto-drive start condition. The rule of how to set a temporary destination may be arbitrarily designed. The rule of setting a temporary destination may be preferably designed so that a temporary destination is flexibly determined according to the current position of the subject vehicle.

For example, the temporary destination setter F4 may set the temporary destination to a position on a nearby road that is reachable in a minimum travel time or via a shortest travel distance from the current vehicle position. The road may include a big, multi-lane road, having two or more travel lanes with bi-directional traffic flows. The road may be defined based on a road type, such as a national road, a regional road, or the like. The road type may be, for example, in a descending order of road class, a national or interstate highway, a state highway, a main road, a street, a narrow street, and the like.

When the subject vehicle is in a relatively large parking facility (e.g., in a parking lot or garage of a large-sized commercial facility), a temporary destination may be set to the exit of the parking facility. The exit of the parking facility is a point that must be passed by the subject vehicle along the way from the current position in the parking facility toward a nearby road/street. Therefore, even in case that a destination of a current trip (i.e., a true destination) is set by the driver's seat occupant during the auto-drive toward the temporary destination, the travel toward an exit of the parking facility exit set as the temporary destination is not necessarily a wasted trip or useless travel.

Further, the temporary destination setter F4 may set the most distant position from the current position as a temporary destination based on the travel history data saved in the travel history storage M1, from among the saved positions that are determined as having a high probability of a probable driving destination. In other words, travel history data may indicate that the subject vehicle drives past a certain distant position with a high frequency and indicate this position as the temporary destination. That is, after sifting the candidate destinations based on a probability of the subject vehicle passing through the destination along the way from the current position to a different position, the most distant position may be picked up as the temporary destination. The temporary destination may always be a specific pre-registered position, or the candidate destinations may be preregistered positions. When a plurality of candidate destinations are preregistered by the user, the temporary destination may be selected and set from the preregistered candidate destinations based on a current time of the day, the number of occupants in the vehicle, or the like.

Further, the temporary destination setter F4 may display a temporary destination selection screen, which displays a plurality of candidate destinations, on the display 83 under control of the HMI system 80 as shown in FIG. 5, for the selection and determination of the temporary destination according to the user operation on the screen. The candidate destinations to be displayed on the screen may be selected and determined by learning from the past travel history, or may be set/registered by the user in advance.

The temporary destination may be, for example, set as a position within a preset distance from the safe area, e.g., a position within several hundred meters. By setting the temporary destination to a position near the safe area, the subject vehicle may further travel to the safe area to stop, in case that a destination has not yet been set at the time of arriving at the temporary destination. The temporary destination may be set to a safe area along the frequently/most-traveled road based on the past travel history.

The auto-drive processor F5 generates a route along which the auto-drive of the subject vehicle is performed based on the travel environment recognized by the environment recognizer F1, and performs a process of the auto-drive of the subject vehicle based on the generated route. Hereafter, for the brevity of description, a process of the auto-drive of the subject vehicle along the generated route based on the travel environment is designated as an auto-drive process.

The auto-drive processor F5 generates a travel route toward a destination of the subject vehicle when the auto-drive start condition is satisfied and the destination information has been obtained by the destination obtainer F2. In case that the auto-drive start condition is satisfied and the destination obtainer F2 has not yet obtained the destination information, a travel route toward the temporary destination (i.e., a provisional route) set by the temporary destination setter F4 is planned/provided.

Further, the auto-drive processor F5 controls a predetermined in-vehicle actuator 60 so that the subject vehicle travels along the generated travel route. The control amount of the in-vehicle actuator 60 may be set for example, based on a current vehicle speed, a current steering angle, a current throttle opening, and the like.

Further, the auto-drive processor F5 performs a process delegating authority to control a travel/drive of the subject vehicle (i.e., drive authority) to and from the driver's seat occupant. For example, in a situation where the operation mode of the vehicle control system is set to the manual drive mode, when a switch operation by the driver's seat occupant to switch to the auto-drive mode is detected, the auto-drive processor F5 performs a process which receives the drive authority from the driver's seat occupant gradually or in a step-wise manner, for a transition to the auto-drive mode. The auto-drive processor F5 also performs a delegation process, transferring/delegating the drive authority back to the driver's seat occupant in a situation in which auto-drive maneuvering is difficult or based on a request from the driver's seat occupant.

The occupant state recognizer F6 determines, in succession, whether a state of the driver's seat occupant is in a capable state for performing the drive operation during the auto-drive based on the occupant state data provided from the occupant state sensor 50. The capable state may be, for example, a state in which the drive authority is transferrable to the driver's seat occupant. In other words, when (i) a level of wakefulness or alertness of the driver's seat occupant is equal to or above a preset level and (ii) a driver's posture is appropriate for the drive operation, it may be determined that the driver's seat occupant is in the capable state. The wakefulness/alertness level of the driver's seat occupant may be determined based on a degree of opening of an eyelid detected by the occupant state sensor 50. The driver's posture appropriate for the drive operation may be determined as, for example, a posture with his/her spine extending substantially upward and straight and his/her face oriented toward a front of the subject vehicle. The occupant state recognizer F6 corresponds to an occupant state determiner.

The vehicle state recognizer F7 identifies the state of the subject vehicle based on the signal input from the vehicle state sensor 40. For example, the vehicle state recognizer F7 determines whether the subject vehicle is in a parked state or not based on an ON-OFF state of a power source for vehicle travel, a lock-unlock state of each door, an output signal of a courtesy switch, and the like.

Further, the vehicle state recognizer F7 detects whether the user has performed a boarding action to board the subject vehicle based on the signal from the vehicle state sensor 40. Detection of the boarding action of the user means, for example, a determination of the user intention to get into the subject vehicle based on an action of the user. That is, the boarding action of the user may be detected as a door handle grasping operation, a door lock opening operation, a door pulling operation, or the like. The boarding action may be detected by the vehicle state recognizer F7 based on an output signal from a touch sensor disposed on the door handle, or based on an output signal from a courtesy switch.

Other than the above, the auto-drive ECU 10 performs other processes during a travel of the subject vehicle, such as saving data regarding a currently-traveled road traveled by the subject vehicle (i.e., a link representing the currently-traveled road) in the travel history storage M1 based on the position information and the map data provided by the locator 20.

<Travel Start Related Process>

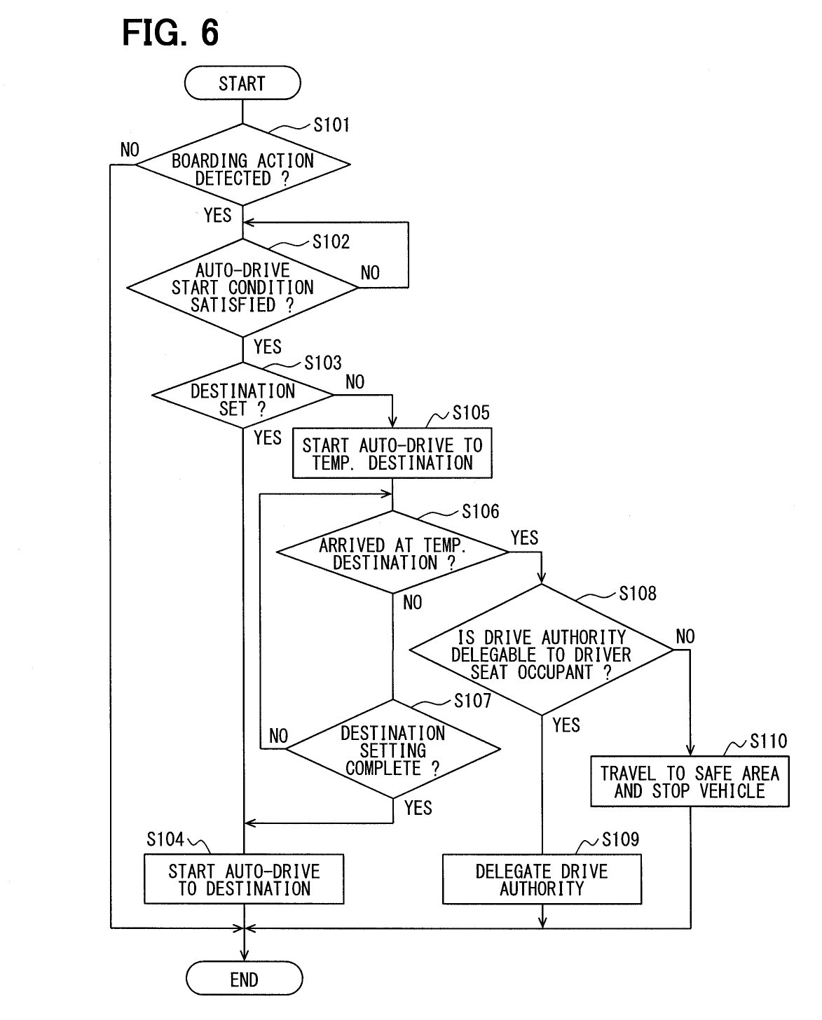

Next, the travel start related process performed by the auto-drive ECU 10 is described with reference to a flowchart shown in FIG. 6. The travel start related process is a process performed by the auto-drive ECU 10 for a vehicle control including a first start, i.e., a first auto-drive in the current trip. The flowcharted process shown in FIG. 6 may be, for example, performed in succession or repeatedly at an interval of 100 milliseconds while the subject vehicle is parked.

At S101, the vehicle state recognizer F7 determines whether the boarding action is performed. When the vehicle state recognizer F7 has detected the boarding action, an affirmative determination is performed at S101, and the process proceeds to S102. On the other hand, when the boarding action is not detected, a negative determination is performed at S101, and the process in the flowchart comes to an end.

At S102, the condition determiner F3 determines whether the auto-drive start condition is satisfied. When the auto-drive start condition is satisfied, an affirmative determination is performed at S102, and the process proceeds to S103. On the other hand, when the auto-drive start condition has not yet been satisfied, a negative determination is performed at S102 and the process returns to S102. S102 is performed at a predetermined interval until the auto-drive start condition is satisfied. In case that the manual drive is started by the driver's seat occupant before the satisfaction of the auto-drive start condition, the process may be ended.

At S103, whether the destination obtainer F2 has obtained the destination or not is determined. In other words, whether the setting of the destination has been complete or not is determined. When the destination has been set, an affirmative determination is performed at S103, and the process proceeds to Step S104. On the other hand, when the destination has not been set, a negative determination is performed at S103, and the process proceeds to S105.

At S104, the auto-drive processor F5 generates a route from the current position to the destination. Further the auto-drive toward the destination is started thereafter and the flow of the process comes to an end.

At S105, the auto-drive processor F5 generates a route from the current position to the temporary destination set by the temporary destination setter F4 (i.e., a provisional route is generated). Further, the auto-drive toward the temporary destination is started, and the process proceeds to S106. Note that, in the present embodiment, when the auto-drive processor F5 performs an automatic travel start of the subject vehicle, the auto-drive processor F5 notifies the driver's seat occupant of the auto-drive of the subject vehicle, under control of the HMI system 80. By providing such notification, the driver's seat occupant is substantially prevented from being surprised, embarrassed, or frustrated in terms of the start of the auto-drive function or when to start the auto-drive function for the subject vehicle. Such notification may be omitted in another mode of operation.

At S106, it is determined by the auto-drive processor F5 whether the subject vehicle has arrived at the temporary destination based on the position information provided by the locator 20. When the subject vehicle has arrived at the temporary destination, an affirmative determination is performed at S106, and the process proceeds to Step S108. On the other hand, when the subject vehicle has not yet arrived at the temporary destination, a negative determination is performed at S106, and the process proceeds to Step S107.

At S107, the destination obtainer F2 determines whether the destination has been set by the occupant. When the destination has been set, an affirmative determination is performed at S107, the process proceeds to S104, and the auto-drive toward the set destination starts. On the other hand, when the destination has not yet been set, a negative determination is performed at S107, and the process returns to S106. That is, the processes at S106 and S107 are repeated until the subject vehicle arrives at the temporary destination or the destination is set.

At S108, it is determined by the occupant state recognizer F6 whether the driver's seat occupant is in a drive authority delegable state based on the occupant state data provided by the occupant state sensor 50. When the driver's seat occupant is in the drive authority delegable state, an affirmative determination is performed at S108, and the process proceeds to S109. On the other hand, when the driver's seat occupant is not in the drive authority delegable state, a negative determination is performed at S108, and the process proceeds to S110.

At S109, while the auto-drive processor F5 performs the auto-drives of the subject vehicle along the route, drive authority is transferred/delegated to the driver's seat occupant. At S110, by setting a nearby safe area as a new temporary destination, a route to the nearby safe area from the current position is generated, and the auto-drive of the subject vehicle is performed toward the nearby safe area. The subject vehicle is stopped after arriving at the safe area by the auto-drive.

<Summary of the First Embodiment>

In the above configuration, when a predetermined auto-drive start condition is satisfied after the boarding of the user onto the subject vehicle, if a destination has been set, the auto-drive processor F5 starts the auto-drive toward the destination. When the auto-drive start condition is satisfied but the destination is not set, the auto-drive processor F5 starts the auto-drive toward a temporary destination.

According to such configuration, even when the destination is not set, the user can automatically start a travel of the subject vehicle automatically toward a predetermined position set as a temporary destination by satisfying the auto-drive start condition, such as wearing a seat belt after boarding. As a result, while moving toward a temporary destination, the driver's seat occupant can set a true destination, and can save time otherwise wasted preparing a start operation such as setting a true travel destination.

The present disclosure described above is not limiting and is open to any modifications and/or changes. Further, the following embodiments may also be combined with the current embodiment in part or as a whole.

### Second Embodiment

The vehicle control system concerning the second embodiment of the present disclosure is described with reference to the drawings. The difference between the first embodiment and the second embodiment is the operation of the auto-drive ECU 10 when the auto-drive start condition is satisfied with no destination setting. Hereafter, the function and operation realized by the auto-drive ECU 10 in the second embodiment are described. The same numerals are assigned to the same components as the first embodiment, and the description of those components is not repeated. When only a part of the configuration is described, the rest of the configuration is borrowed from the first embodiment.

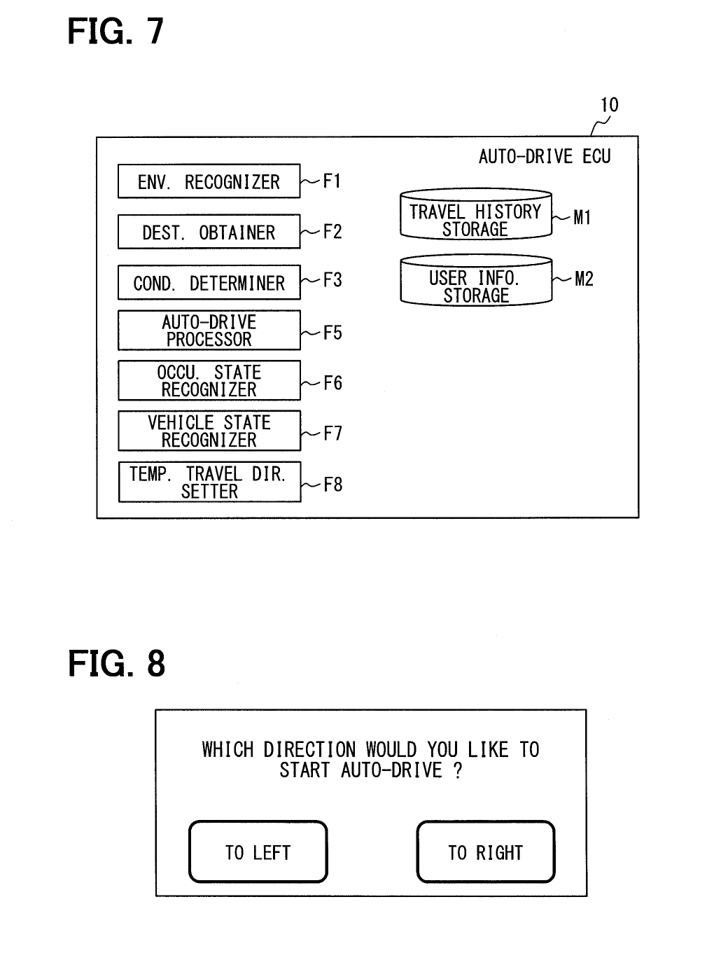

The auto-drive ECU 10 in the present embodiment is provided with the environment recognizer F1, the destination obtainer F2, the condition determiner F3, the auto-drive processor F5, the occupant state recognizer F6, the vehicle state recognizer F7, a temporary travel direction setter F8, the travel history storage M1, and the user information storage M2 as shown in FIG. 7. That is, instead of the temporary destination setter F4, it has the temporary travel direction setter F8.

The temporary travel direction setter F8 operates in the following manner. That is, when it is determined by the condition determiner F3 that as the auto-drive start condition has been satisfied and the destination obtainer F2 has not obtained the destination information, the temporary travel direction setter F8 determines, i.e., sets, a travel direction of the subject vehicle at a nearby road that is nearest/proximate to the current position of the subject vehicle based on a predetermined rule. When the subject vehicle is in a non-road area, e.g., in a parking facility/building, the temporary travel direction setter F8 determines whether to travel the road along the non-road area (i.e., the nearby road) toward the left or toward the right in a driver's view, i.e., when a person sees the nearby road from an inside of the non-road area.

The travel direction on a nearby road may be set in advance by the user. The setup information for the travel direction on a nearby road may be registered to the user information storage M2. In such case, the temporary travel direction setter F8 automatically determines the travel direction on a nearby road based on the setup information registered to the user information storage M2. Further, the travel direction on a nearby road may also be determined by traffic regulations of the nearby road. For example, when a nearby road is a one-way road according to the traffic regulation, the direction specified by the traffic regulation is adopted as a travel direction. When a nearby road is a road provided with two or more lanes, the temporary travel direction setter F8 may set the travel direction of the subject vehicle on the nearby road according to the travel direction of the nearest lane from the current position of the subject vehicle.

Further, the temporary travel direction setter F8 may display a travel direction selection screen on the display 83 based on the satisfaction of the auto-drive start condition, for allowing the user to select a travel direction on a nearby road as shown in FIG. 8, and the travel direction on a nearby road may be determined based on the occupant's selection operation performed on the selection screen. Hereafter, the travel direction on the nearby road set by the temporary travel direction setter F8 may be designated as a temporary travel direction.

If the subject vehicle is stopped or parked on a road, i.e., on a shoulder of a road, at a time of user boarding (i.e., when a boarding action of the user is detected), the road on which the subject vehicle is parked is the nearby road. When the subject vehicle is parked on a shoulder of a road, the travel direction of the nearest lane of such road nearest to the subject vehicle is adopted as the temporary travel direction.

The auto-drive processor F5 in the present embodiment starts the auto-drive (i) by exiting from the current position/area onto a nearby road and (ii) by planning a provisional route that is a route of travel on a nearby road in the temporary travel direction set by the temporary travel direction setter F8, when the auto-drive start condition is satisfied and the destination obtainer F2 has not obtained the destination information. The travel route planned/generated at a destination information not-yet obtained time, i.e., the provisional route, includes a path to exit from a parking facility/building to a nearby road. Further, the route after such an exit to the nearby road may be set as a travel route along the travel direction of such a road or a lane of the road.

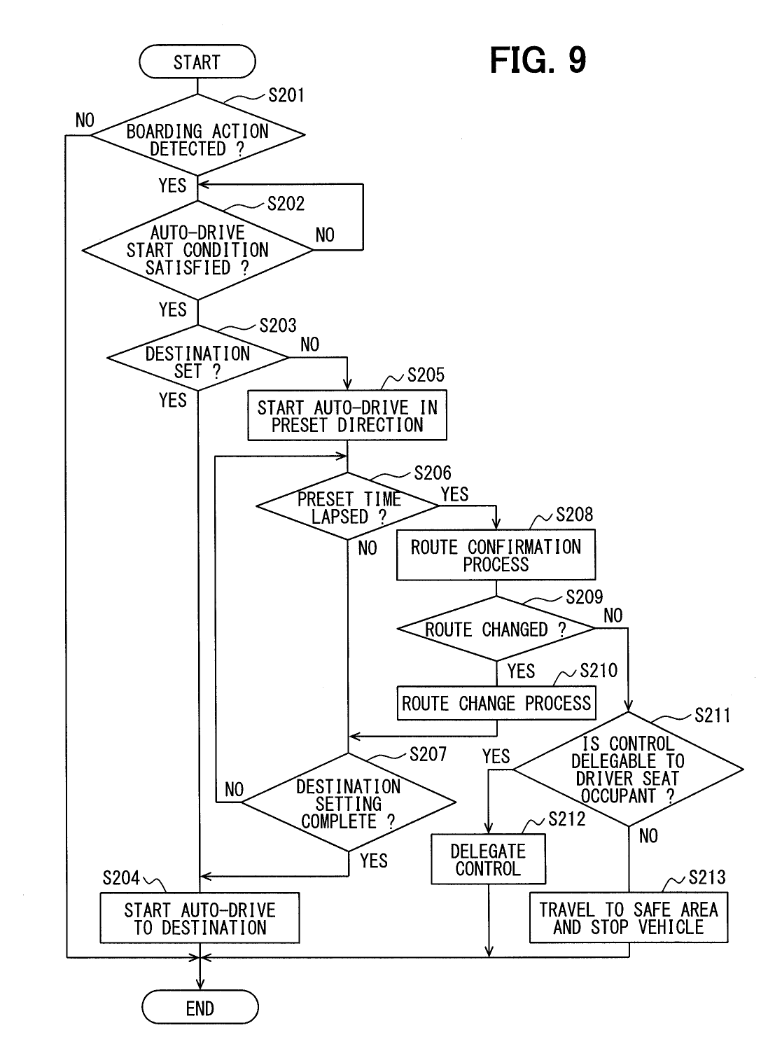

Next, a travel start related process performed by the auto-drive ECU 10 in the second embodiment is described with reference to a flowchart shown in FIG. 9. Just like the flowchart shown in FIG. 6, the flowchart shown in FIG. 9 may be, in succession, performed at predetermined interval of 100 milliseconds, for example, when the subject vehicle is parked. The subject vehicle is, for example, assumed as being parked in a parking facility when the flowcharted process of FIG. 9 is started.

The contents of process at S201-S204 in FIG. 9 are the same as the contents of process at S101-S104 in the first embodiment. Therefore, description of the processes at S201-S204 is omitted. When the travel start condition is satisfied and the destination is not set, a negative determination is performed at S203, and the process proceeds to S205.

At S205, the auto-drive processor F5 generates a travel route (i.e., a provisional route) for performing the auto-drive on the nearby road in the temporary travel direction and starts an auto-drive. When the process at S205 is complete, the process proceeds to S206.

At S206, the auto-drive processor F5 determines whether a preset amount of time has lapsed after starting the auto-drive in a no-destination-set state. The amount of time for the determination of the process at S206 may be arbitrarily determined by design. For example, 3 minutes, 5 minutes, or the like may be useable as a determination time. The value may also be a relatively-long time, e.g., 10 minutes, 30 minutes or the like. The preset amount of time used at S206 may be a fixed value or may be a variable value, i.e., a value settable/changeable by the user. When the time lapsed after starting the auto-drive is equal to or greater than a preset value, an affirmative determination is performed at S206, and the process proceeds to S208. On the other hand, when the preset time has not yet lapsed, a negative determination is performed at S206, and the process proceeds to S207.

At S207, the destination obtainer F2 determines whether the destination is set or not. When the destination is set, an affirmative determination is performed at S207, the process proceeds to S204, and starts the auto-drive toward the set destination. On the other hand, when the destination is not yet set, a negative determination is performed at S207, and the process returns to S206.

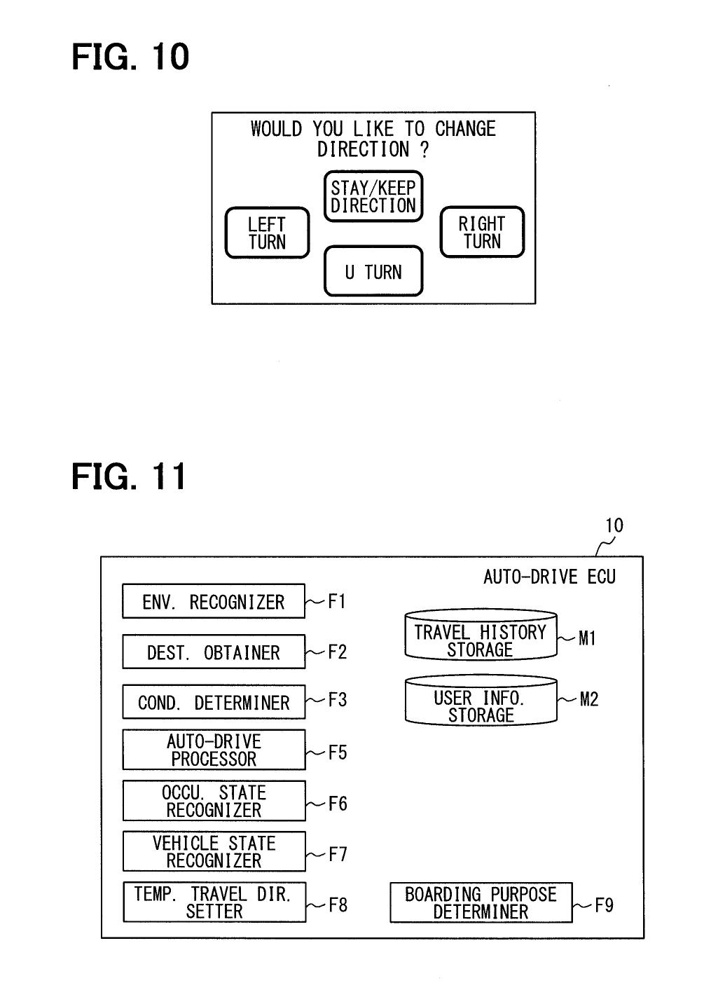

At S208, the auto-drive processor F5 performs a route confirmation process. The route confirmation process is an inquiry process for asking the driver's seat occupant whether the current travel direction is a travel direction desired by the driver's seat occupant. For example, the auto-drive processor F5 displays a route confirmation screen on the display 83, and determines whether the travel direction should stay as is, or should be changed based on the occupant's selection operation on the route confirmation screen. The route confirmation screen is a screen asking for a user input regarding whether the current travel direction is a desired travel direction of the driver's seat occupant. The route confirmation screen may display, for example, options of travel directions for an input of a desired direction by the driver's seat occupant, as shown in FIG. 10. According to such configuration, the driver's seat occupant can input, i.e., instruct, a desired travel direction to the auto-drive ECU 10.

When the driver's seat occupant, as a result of the route confirmation process at S208, inputs/instructs a change of the travel direction to a desired one, an affirmative determination is performed at S209, and the process proceeds to S210. When, as a result of the route confirmation process, staying in the current travel direction is input, an affirmative determination is performed at S209, and the process proceeds to S211.

At S210, a travel route is corrected so that the subject vehicle travels along a driver's seat occupant instructed/desired route or travel direction, if such an input is received in the route confirmation process. That is, the auto-drive of the subject vehicle is performed in accordance with such a travel route. For example, when a right turn is input at S208, a right-turn intersection is looked up and identified from among the intersections in front of the subject vehicle, and a travel route that turns right at such intersection is generated. Then, the auto-drive along such a route is performed. Note that after the right turn, it is assumed that the auto-drive is performed along an after-right-turn road. When correction of the travel route at S210 is complete, the process proceeds to S207. By repeating the processes at S206 to S209, the travel direction of the subject vehicle is set in the driver's seat occupant desired direction. When a right turn, a left turn, a U turn, or the like is performed based on the route change instructed at S210, the elapsed time used in the determination at S206 is an amount of time that has elapsed after performing the right turn route change.

At S211, the occupant state recognizer F6 determines whether the driver's seat occupant is in a capable state in which drive authority may be transferrable/delegable to him/her based on the occupant state data provided from the occupant state sensor 50. When the driver's seat occupant is in a capable state where drive authority may be transferred or delegated, the process proceeds to S212. On the other hand, when the driver's seat occupant is not in a capable state, i.e., a state in which drive authority is not transferrable/delegable, a negative determination is performed at S211, and the process proceeds to S213. The determination process at S211 may be performed after a preset amount of time has lapsed from an input/instruction of staying in an as-is direction at S208.

At S212, while performing the auto-drive of the subject vehicle along the road, the auto-drive processor F5 transfers/delegates a drive authority to the driver's seat occupant. At S213, after performing the auto-drive of the subject vehicle from the current position to a nearby safe area, the auto-drive processor F5 stops the subject vehicle in the safe area.

<Summary of the Second Embodiment>

In the above-described configuration, when a user boards the subject vehicle, a predetermined auto-drive start condition is satisfied, and a destination is set, the auto-drive processor F5 starts an auto-drive of the subject vehicle toward a set destination. When the auto-drive start condition is satisfied and the destination is not set, the auto-drive processor F5 starts a process for performing an auto-drive along a nearby road from the current position in a predetermined direction.

According to such configuration, the same effects as the first embodiment mentioned above are achieved. Further, according to the second embodiment, if a route change instruction is input every time the route confirmation process is performed, the auto-drive of the subject vehicle is able to continue without performing a destination setting. For example, the auto-drive of the subject vehicle may be performable only for a diversion or the like, for example, driving around for fun without a preset destination, and for using the subject vehicle for purposes other than travel to a certain/fixed destination.

### [Third Embodiment]

The user may use the vehicle compartment of the auto-driving vehicle as a work space, a movie theater, a room for taking a nap, or the like. As a result, it is naturally assumed that a vehicle capable of performing auto-drive may be used for the purposes other than travel. However, when the user uses the subject vehicle for purposes other than travel, such as a sleep or the like, no destination is set. Therefore, in other words, even when no destination is set for the auto-drive of the subject vehicle, simply continuing an auto-drive of the subject vehicle may be foreseen as a need of the user.

The vehicle control system concerning the third embodiment of the present disclosure is created and configured for satisfying such a need as one of the travel purposes. The vehicle control system of the third embodiment is provided with the same configuration as the vehicle control system of the first and second embodiment described above. The difference between the system in the third embodiment and the system in the first and second embodiment is the operation of the auto-drive ECU 10 in case of no destination setting. Hereafter, the function and operation of the auto-drive ECU 10 in the third embodiment are described. The same numerals are assigned to the same components as the first/second embodiment, and the description of those components is not repeated. When only a part of the configuration is described, the rest of the configuration is borrowed from the first/second embodiment.

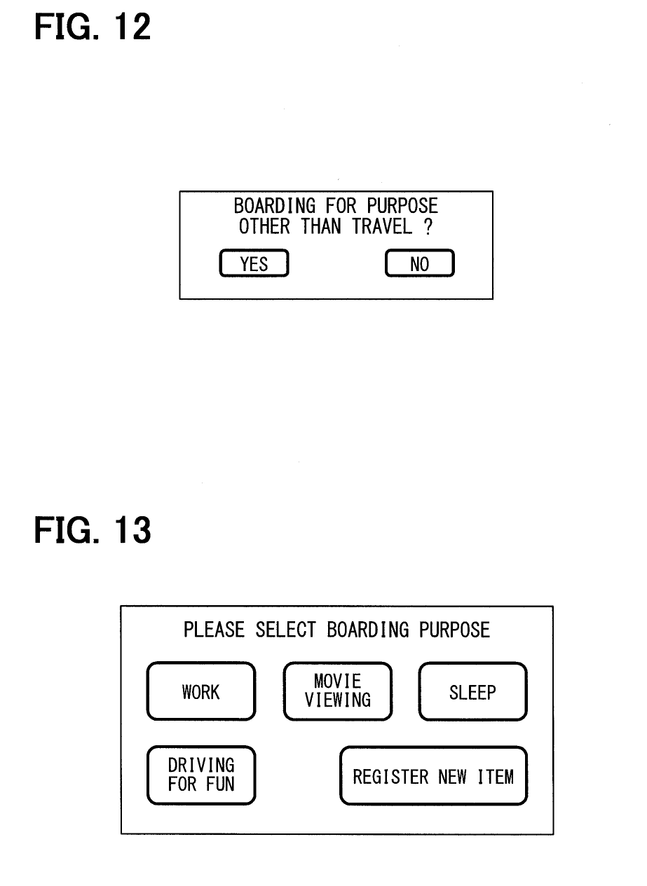

In addition to the various functions provided by the auto-drive ECU 10 of the second embodiment, the auto-drive ECU 10 in the third embodiment is provided with a boarding purpose determiner F9 as shown in FIG. 11. The boarding purpose determiner F9 is a configuration for identifying a boarding purpose of the driver's seat occupant in cooperation with the HMI system 80, when the auto-drive is being performed/continued when no destination has been set. In other words, the boarding purpose determiner F9 identifies the boarding purpose based on an input operation of the driver's seat occupant. For example, as shown in FIG. 12, a purpose confirmation screen that asks a user whether he/she has a boarding purpose other than travel is displayed on the display 83 by the boarding purpose determiner F9, and, based on the occupant's selection on the purpose confirmation screen, identifies whether the user has any other purposes other than travel. When an operation indicating an other-than-travel purpose is performed, a purpose selection screen as shown in FIG. 13 is displayed, and the boarding purpose is identified based on the occupant's selection on the purpose selection screen. The boarding purpose may be identified by another method other than using the purpose selection screen. That is, the boarding purpose may be identified vocally, by a combination of (i) output of a voice message for asking the purpose and (ii) an input of a voice response to such message from the driver's seat occupant, without using a screen display.

Further, the auto-drive processor F5 in the present embodiment has an excursion mode as an operation mode for the user who is boarding for other purpose other than travel. The excursion mode is an operation mode in which a process is performed (i) for generating a travel route (i.e., an excursion route) that provides a travel time suitable for the boarding purpose of the user and (ii) for performing an auto-drive of the subject vehicle along the excursion route. For example, when the boarding purpose identified by the boarding purpose determiner F9 is movie viewing, an excursion route with a travel time that is just about the duration of the movie play time may be planned and generated. Further, when the boarding purpose identified by the boarding purpose determiner F9 is sleep or work, an excursion route is generated as a route with a travel time that is preset by a designer of the auto-drive apparatus or by the driver's seat occupant.

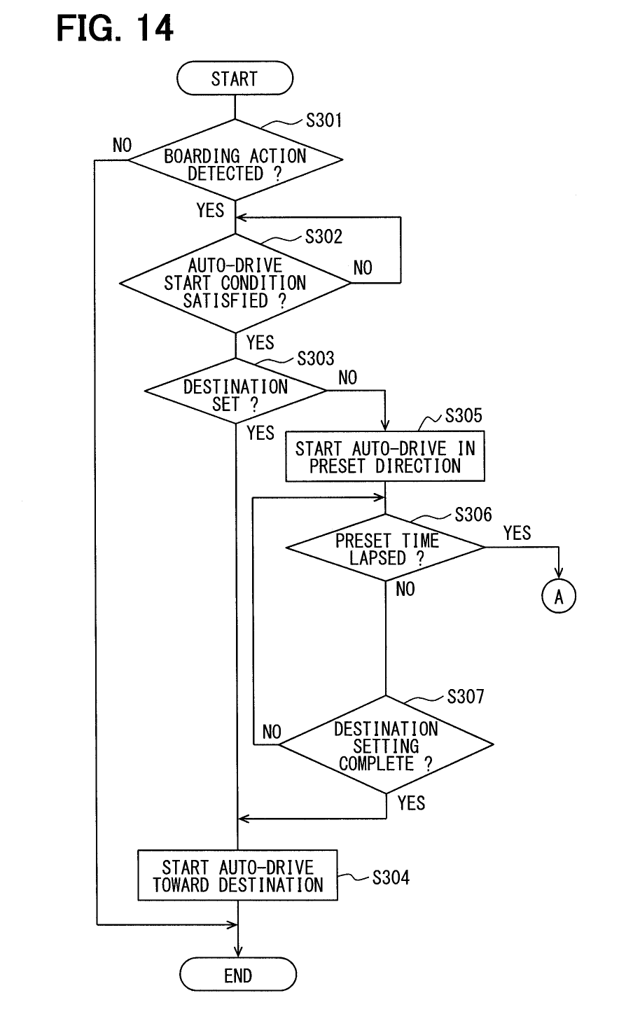

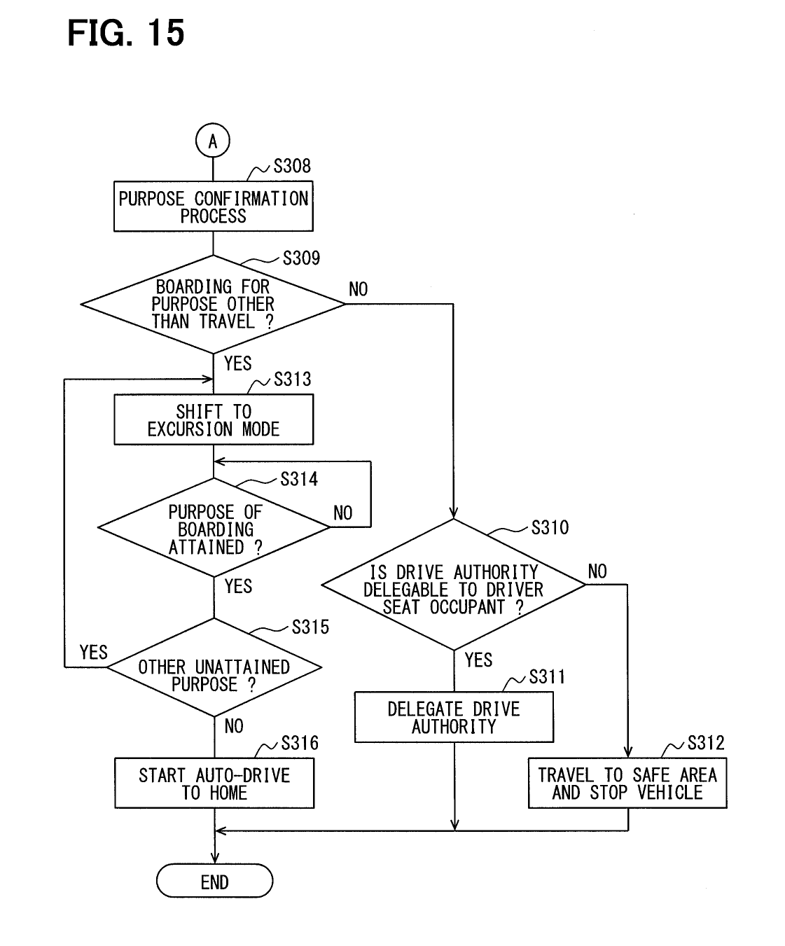

The travel start related process performed by the auto-drive ECU 10 of the third embodiment is described with reference to the flowchart shown in FIGS. 14-15. Just like the flowchart shown in FIG. 6, the flowchart in FIG. 14 may be performed in succession (e.g., at an interval of 100 milliseconds) while the subject vehicle is parked. The following description is based on an assumption that, at the start of the processes illustrated in the flowchart, the subject vehicle is parked at a user's house.

The contents of process at S301-S307 shown in FIG. 14 are the same as the contents of processes described at S201-S207 for the second embodiment. Therefore, the description of the processes at S301-S307 is omitted.

When a preset time has lapsed after starting the auto-drive in the state where the destination is not set, the process proceeds to S308, which is a result of an affirmative determination at S306, as shown in FIG. 15.

At S308, the boarding purpose determiner F9 performs a purpose confirmation process. The purpose confirmation process is a process that displays the purpose confirmation screen on the display 83, and identifies the occupant's boarding purpose, i.e., whether the occupant has any purpose other than travel based on the occupant's selection operation on the purpose confirmation screen. Further, when a purpose other than travel is input from such screen, the boarding purpose of the driver's seat occupant is identified by displaying the purpose selection screen on the display 83.

As a result of the purpose confirmation process at S308, when the driver's seat occupant inputs a boarding purpose other than travel, an affirmative determination is performed at S309, and the process proceeds to S313. On the other hand, when an input of the driver's seat occupant indicates that there is no boarding purpose other than travel to a destination, as a result of the purpose confirmation process, a negative determination is performed at S309, and the process proceeds to S310.

At S310, the occupant state recognizer F6 determines whether the driver's seat occupant is in a capable state in which drive authority may be transferrable/delegable based on the occupant state data provided from the occupant state sensor 50. When the driver's seat occupant is in a capable state in which a drive authority may be transferred/delegated, the process proceeds to S311. On the other hand, when the driver's seat occupant is not in a capable state where drive authority can be transferred/delegated, the process proceeds to S312.

At S311, the auto-drive processor F5 transfers/delegates drive authority to the driver's seat occupant while controlling the auto-drive according to a travel route along the road. At S312, the auto-drive processor F5 performs the auto-drive of the subject vehicle from the current position to a nearby safe area, and stops the subject vehicle in the safe area.

At S313, the auto-drive processor F5 sets the operation mode to the excursion mode, and plans an excursion route based on the driver seat occupant's boarding purpose. Then, the auto-drive processor F5 starts a process for performing the auto-drive of the subject vehicle along the excursion route. The auto-drive processor F5 determines, in succession, whether the subject vehicle has arrived at the end of the excursion route, i.e., an end of a series of short trips intended as an excursion planned in S313, based on the position information provided from the locator 20.

When the auto-drive processor F5 determines that the vehicle has arrived at the end of the excursion route, it performs an inquiry process that asks, in cooperation with the HMI system 80, whether an original boarding purpose has been completed. The inquiry process itself may be performed, for example, while performing the auto-drive along a travel/excursion route on the road. As a result of the inquiry process, when the driver's seat occupant inputs that the boarding purpose is attained, an affirmative determination is performed at S314, and the process proceeds to S315. When the driver's seat occupant inputs that the boarding purpose has not been attained, a negative determination is performed at S314 and the process proceeds to S315. An interval of such inquiry process, i.e., how often the attainment of the boarding purpose should be asked by performing S314, may be arbitrarily set. Further, an interval to the next inquiry process may be set by the driver's seat occupant. The excursion mode is continued until the boarding purpose is attained.

At S315, it is determined, i.e., the vehicle occupant is asked, by the boarding purpose determiner F9 whether there is any other unattained boarding purposes, in cooperation with the HMI system 80. When an input from the vehicle occupant indicates that there is other boarding purpose(s) yet unattained, the process returns to S313, and a new excursion route is planned according to a newly input boarding purpose. A subsequent process is the same as above. On the other hand, at S315, when an input indicates that there is no other boarding purpose, the process proceeds to S316.

At S316, a route to a new temporary destination, which may be a user's home, i.e., a storage location of the subject vehicle, is generated, and the auto-drive of the subject vehicle is performed toward the new temporary destination, or toward a nearby safe area. When the subject vehicle arrives at the nearby safe area, the subject vehicle stops in such area.

<Summary of the Third Embodiment>

In the above configuration, when a user boards a subject vehicle, a predetermined auto-drive start condition is satisfied, and a destination is already set, the auto-drive processor F5 starts the auto-drive toward the set destination. On the other hand, when the auto-drive start condition is satisfied and a destination is not yet set, the auto-drive processor F5 starts a process for performing an auto-drive in a preset direction along the nearby road that is nearest to the current position.

After a lapse of a preset amount of time from the start of the auto-drive in a state in which no destination is set, the driver's seat occupant is asked about his/her boarding purpose, and when the boarding purpose of the driver's seat occupant is a purpose other than travel, the process shifts an operation mode to an excursion mode and an auto-drive is continued.

According to such configuration, while achieving the same effects as the first and second embodiments described above, a user need such as using the passenger compartment of the auto-driving subject vehicle as a work space, a movie theater, a room for taking a nap, or the like may be accommodated.

Although the configuration of the third embodiment is described based on the configuration of the second embodiment, the configuration of the present embodiment is not limited to the above. The configuration and technical thought disclosed as the third embodiment may be applicable to the first embodiment. For example, the boarding purpose determiner F9 may perform the purpose confirmation process when the subject vehicle arrives at a temporary destination.

Although the present disclosure has been fully described in connection with preferred embodiment thereof with reference to the accompanying drawings, it is to be noted that various changes and modifications will become apparent to those skilled in the art, and such changes, modifications, and summarized schemes are to be understood as being within the scope of the present disclosure as defined by appended claims.

What is claimed is:

1. An auto-drive apparatus comprising:
a destination obtainer configured to obtain a travel destination of a subject vehicle;
an auto-drive processor configured to control an auto-drive of the vehicle toward the destination obtained by the destination obtainer;
a condition determiner configured to determine whether an auto-drive start condition is satisfied based on an input signal from a device disposed in the vehicle, wherein the auto-drive start condition is a condition to start the auto-drive of the vehicle in a stop state; and
a temporary destination setter configured to set a temporary destination according to a preset rule when no destination has been obtained by the destination obtainer prior to the condition determiner determining that the auto-drive start condition is satisfied,
wherein the auto-drive processor starts the auto-drive of the vehicle toward the temporary destination set by the temporary destination setter when no destination has been obtained by the destination obtainer prior to the condition determiner determining that the auto-drive start condition is satisfied.

2. The auto-drive apparatus of claim 1, wherein
the temporary destination setter displays, on a display device installed in the subject vehicle, a temporary destination selection screen showing a plurality of locations as candidates of the temporary destination, and determines, as the temporary destination, one of the candidates of the temporary destination based on an operation performed on the temporary destination selection screen.

3. The auto-drive apparatus of claim 2 further comprising:
a travel history storage configured to store a travel history data for a travel history of the vehicle including a road on which the subject vehicle has traveled, wherein
the temporary destination setter determines a candidate location of the temporary destination based on the travel history data stored in the travel history storage.

4. The auto-drive apparatus of claim 1, wherein
the temporary destination setter sets, as the temporary destination, either a safe area where the subject vehicle is stoppable without obstructing traffic or a proximate position within a preset distance from the safe area.

5. The auto-drive apparatus of claim 1 further comprising:
an occupant state determiner configured to determine whether a driver's seat occupant sitting in a driver's seat of the vehicle is capable of performing a drive operation based on a sensor data from an occupant sensor that detects an occupant state of the vehicle occupant in the driver's seat, wherein
the auto-drive processor performs a drive authority delegation process for delegating a drive authority to the driver's seat occupant when the destination is not set when the vehicle arrives at the temporary destination and the occupant state determiner determines that the driver's seat occupant is in a capable state for performing the drive operation, and
the auto-drive processor performs the auto-drive of the vehicle to a nearest safe area that is nearest to the temporary destination and stops the vehicle when the occupant state determiner determines that the driver's seat occupant is not in the capable state for performing the drive operation.

6. An auto-drive apparatus comprising:
a destination obtainer configured to obtain a travel destination for a subject vehicle;
an auto-drive processor configured to control an auto-drive of the subject vehicle toward the destination obtained by the destination obtainer;
a condition determiner configured to determine whether an auto-drive start condition is satisfied based on an input signal from a device disposed in the subject vehicle, wherein the auto-drive start condition is a condition to start the auto-drive of the subject vehicle in a stop state; and
a destination obtainer configured to obtain a travel destination for the subject vehicle;
an auto-drive processor configured to control an auto-drive of the vehicle toward the destination obtained by the destination obtainer;
a condition determiner configured to determine whether an auto-drive start condition is satisfied based on an input signal from a device disposed in the vehicle, wherein the auto-drive start condition is a condition for starting the auto-drive of the subject vehicle; and
a temporary travel direction setter configured to set a travel direction of the vehicle on a nearby road that is nearest or proximate to a current position of the vehicle according to a preset rule when no destination has been obtained by the destination obtainer prior to the condition determiner determining that the auto-drive start condition has been satisfied, wherein
the auto-drive processor starts the auto-drive on the nearby road in which the vehicle travels in a travel direction that is set by the temporary travel direction setter when no destination has been obtained by the destination obtainer prior to the condition determiner determining that the auto-drive start condition has been satisfied.

7. The auto-drive apparatus of claim 6 further comprising:
an occupant state determiner configured to determine whether a driver's seat occupant sitting in a driver's seat of the vehicle is capable of performing a drive operation based on a sensor data from an occupant sensor that detects an occupant state of the vehicle occupant in the driver's seat, wherein
the auto-drive processor performs a drive authority delegation process for delegating a drive authority to the driver's seat occupant when an auto-drive of the vehicle is continued for a preset period of time in a destination-not-set state and the occupant state determiner determines that the driver's seat occupant is in a capable state for performing the drive operation, and
the auto-drive processor performs the auto-drive of the vehicle to and stops the vehicle in a nearby safe area nearest to the current position of the vehicle when the occupant state determiner determines that the driver's seat occupant is not in the capable state for performing the drive operation.

8. The auto-drive apparatus of claim 1 further comprising:
a boarding purpose identifier configured to identify a boarding purpose of the vehicle occupant based on an operation by the vehicle occupant when the auto-drive of the vehicle in a destination-not-set state is performed by the auto-drive processor, wherein
the auto-drive processor plans an excursion route that provides the vehicle occupant with a suitable travel time according to the boarding purpose identified by the boarding purpose identifier, and performs the auto-drive of the vehicle along the planned excursion route.

9. The auto-drive apparatus of claim 1 further comprising:
an authority data storage configured to store authorization data for an auto-drive authorized person who is authorized to start the auto-drive of the vehicle by the auto-drive processor; and
an occupant determiner configured to determine whether the authorized person is on board of the vehicle based on the authority data stored in the authority data storage, wherein
the auto-drive start condition includes a criterion of whether the occupant determiner has determined that the auto-drive authorized person is on board.

10. The auto-drive apparatus of claim 1, wherein
the condition determiner determines whether the vehicle occupant would like to start the auto-drive of the vehicle based on the operation of the vehicle occupant, and determines that the auto-drive start condition is satisfied based on a determination that the vehicle occupant would like to start the auto-drive of the vehicle.
